(19) United States
(12) Patent Application Publication
(10) Pub. No.: US 2010/0272900 A1
(43) Pub. Date: Oct. 28, 2010

(54) Method of fabricating zinc oxide nanowire using supersonic energy

(76) Inventors: Wan-jun Park, Seoul (KR); Soo-hwan Jeong, Seoul (KR)

Correspondence Address: HARNESS, DICKEY & PIERCE, P.L.C., P.O. BOX 8910, RESTON, VA, 20195, US

(21) Appl. No.: 12/003,869

(22) Filed: Jan. 3, 2008

(30) Foreign Application Priority Data
Jan. 3, 2007 (KR) 10-2007-0000701

(51) Int. Cl. B05D 1/32; B05D 3/00

(52) U.S. Cl. 427/282; 427/331

(57) ABSTRACT

Provided is a method of fabricating ZnO nanowires using a sonicator. The method includes (a) forming a Zn layer on a surface of a substrate, (b) patterning the Zn layer, and (c) forming ZnO nanowires on the Zn layer by immersing the substrate, on which the Zn layer is patterned in a mixed solution made of a solution containing Zn and a solution ionizing Zn, in a sonicator. ZnO nanowires may be formed at a predetermined location at room temperature according to the present invention.

### CROSS-REFERENCE TO RELATED PATENT APPLICATION

This application claims the benefit of Korean Patent Application No. 10-2007-0000701, filed on Jan. 3, 2007, in the Korean Intellectual Property Office, the disclosure of which is incorporated herein in its entirety by reference.

### BACKGROUND OF THE INVENTION

1. Field of the Invention

The present invention relates to a method of fabricating a ZnO nanowire using supersonic energy, and more particularly, to a method of growing a nanowire using supersonic energy and a method of defining a growing location of the nanowire.

2. Description of the Related Art

Generally, a nano-scale material has different physical and chemical characteristics from the same material that has a macro size due to a large ratio of surface to mass. The nano-scale material may be employed for an optical catalyst that uses a chemical reaction generated on a surface thereof, an electronic device, or an optical device.

Nanowires may have a diameter of a few nm to a few hundreds of nm and may be grown to a length of a few tens to a few thousands times the diameter. The nanowires show various electrical, chemical, physical, and optical characteristics unlike a characteristic shown in a conventional bulk structure. Further, minute and integrated devices may be realized using the above characteristics.

Nanowires presently under studying include metal nanowires, non-metal nanowires, metal oxide nanowires, and silicon carbide nanowires.

Methods of fabricating such nanowires include a chemical polymerization method, an electrochemical polymerization method, a chemical vapor deposition (CVD) method, and a carbothermal reduction method.

ZnO semiconductor nanowires are basic elements for realizing nano-scale electronic devices, optical devices, or sensors, and many new techniques have disclosed in this field. However, in order to obtain high quality nanowires, there are several technical limitations such as high synthetic temperature, long synthetic hours, expensive vacuum equipment, or the use of a harmful gas. Although high quality nanowires are obtained, a location control technique, that is, locating the nanowire on a desired position of a substrate is one of the limiting factors for the practical use of the nanowire devices.

### SUMMARY OF THE INVENTION

The present invention provides a method of fabricating ZnO nanowires at room temperature using supersonic energy.

The present invention also provides a method of locating the ZnO nanowires on a desired location of a substrate.

According to an aspect of the present invention, there is provided a method of fabricating ZnO nanowires, comprising: (a) forming a Zn layer on a surface of a substrate; (b) patterning the Zn layer; and (c) forming ZnO nanowires on the Zn layer by immersing the substrate on which the Zn layer is patterned in a mixed solution made of a solution containing Zn and a solution ionizing Zn and by using a sonicator.

The solution containing Zn may be a zinc nitrate hexahydrate (Zn(NO₃)₂.6H₂O) solution, and the solution ionizing Zn may be a hexamethylenetetramine ((CH₂)₆N₄) solution.

The mixed solution may be made by mixing the hexamethylenetetramine (CH₂)₆N₄) solution and the zinc nitrate hexahydrate (Zn(NO₃)₂.6H₂O) solution in a concentration ratio of 1:1.

Concentrations of the hexamethylenetetramine (CH₂)₆N₄) solution and the zinc nitrate hexahydrate (Zn(NO₃)₂.6H₂O) solution respectively may be 0.01 to 1 M and more preferably, 0.01 to 0.05 M.

The substrate may be one selected from the group consisting of a silicon substrate, a plastic substrate, and a glass substrate.

According to another aspect of the present invention, there is provided a method of fabricating ZnO nanowires, comprising: (a) forming a patterned photoresist layer on a substrate; (b) forming a Zn layer on the substrate and the photoresist layer; (c) forming ZnO nanowires on the Zn layer by immersing the substrate in a mixed solution made of a solution containing Zn and a solution ionizing Zn and by using a sonicator; and (d) removing the photoresist layer.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view for illustrating a method of fabricating ZnO nanowires using supersonic energy, according to an embodiment of the present invention;

FIGS. 2A through 2C are scanning electronic microscopic (SEM) images of ZnO nanowires respectively grown on a silicon substrate, a glass substrate, and a plastic substrate;

FIGS. 3A through 3D are cross-sectional views for illustrating a method of growing ZnO nanowires on a predetermined region, according to another embodiment of the present invention; and

FIG. 4 is a SEM image of ZnO nanowires grown in a stripe region of a silicon substrate.

### DETAILED DESCRIPTION OF THE INVENTION

The present invention will now be described more fully with reference to the accompanying drawings in which exemplary embodiments of the invention are shown. In the drawings, the thicknesses of layers and regions are exaggerated for clarity.

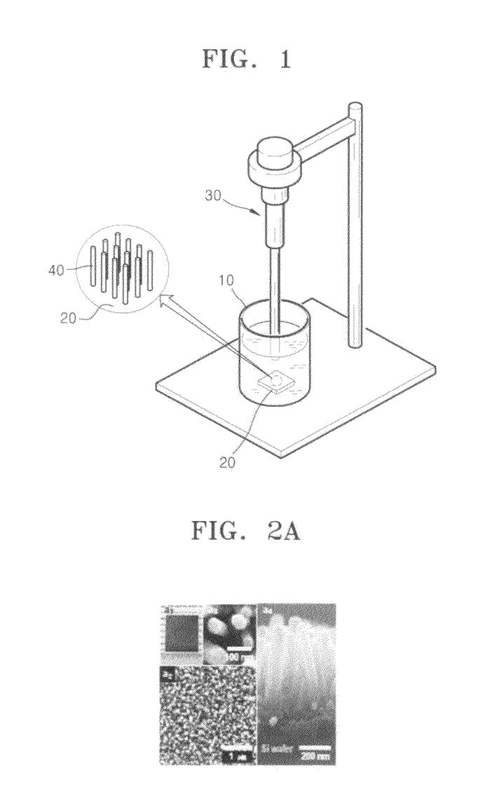

FIG. 1 is a perspective view for illustrating a method of fabricating ZnO nanowires using supersonic energy, according to an embodiment of the present invention.

Referring to FIG. 1, after a Zn substrate 20 or a substrate on which Zn is coated is immersed in a container 10 including a mixed solution of hexamethylenetetramine ((CH₂)₆N₄) and zinc nitrate hexahydrate (Zn(NO₃)₂.6H₂O), and ZnO nanowires 40 are grown on the Zn substrate 20 by operating a sonicator 30.

The following equations indicate a mechanism of growing the ZnO nanowires on a Zn material.

When water is added to the hexamethylenetetramine, as shown in Equations 1 and 2, ammonium ions are generated. The ammonium ions ionize Zn.

(CH₂)₆N₄+6H₂O→4 NH₃+6HCHO [Equation 1]

NH₃+H₂)→NH₄⁺+OH⁻ [Equation 2]

Next, as shown in Equation 3, the ammonium ion reacts with Zn on the Zn substrate 20 to produce Zn ions.

Zn+2NH₄+→Zn²⁺+2NH₃+H₂ [Equation 3]

As shown in Equation 4, zinc hydroxide is produced by reacting Zn ion with a hydroxide radical.

Zn²⁺+4OH⁻→Zn(OH)₄²⁻ [Equation 4]

Zn(OH)₄²⁻→ZnO [Equation 5]

Referring to Equation 5, the zinc hydroxide becomes ZnO, and at this point, a ZnO seed layer is formed on the Zn substrate 20.

The zinc nitrate hexahydrate ((Zn(NO₃)₂.6H₂O) solution including Zn supplies Zn to the ZnO seed layer. As a result, ZnO nanowires are grown on the ZnO seed layer.

In the present embodiment, bubbles are grown in the mixed solution at room temperature using the sonicator 30, and a ZnO material is formed on the Zn substrate 20 due to high temperature and high pressure conditions locally provided by breaking the bubbles.

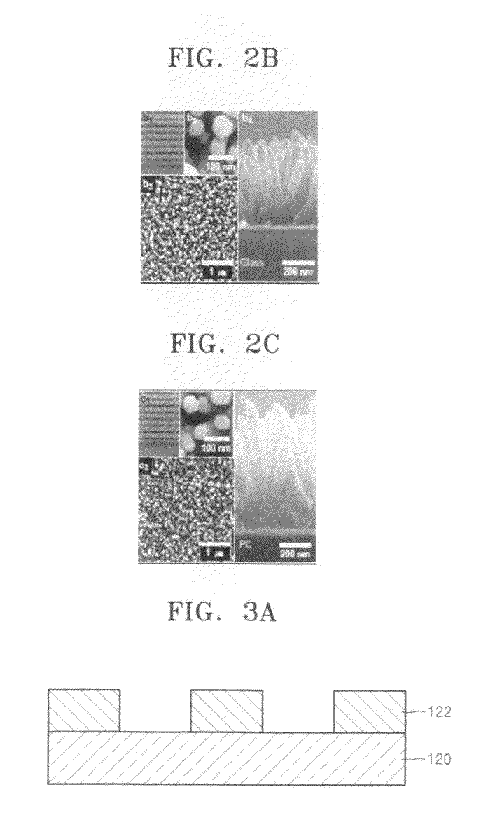

FIG. 2A through 2C are scanning electronic microscopic (SEM) images of ZnO nanowires respectively grown on a silicon substrate, a glass substrate, and a plastic substrate.

Referring to FIGS. 2A through 2C, the ZnO nanowires may be grown not only on a silicon substrate but also on a transparent glass substrate and a transparent plastic substrate.

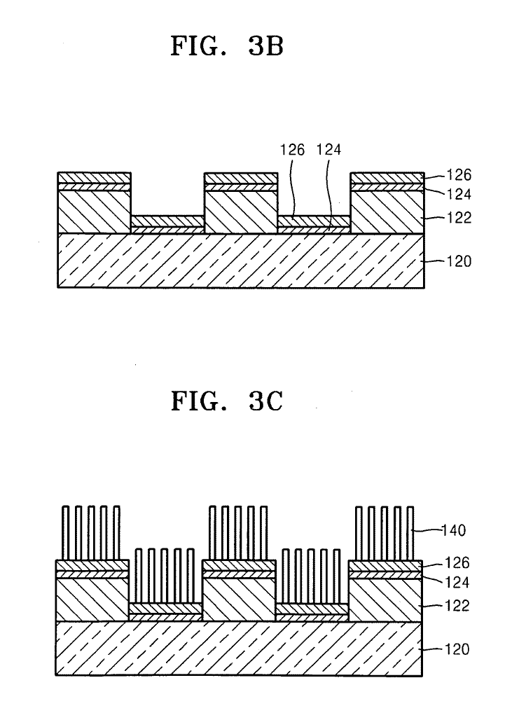

FIGS. 3A through 3D are cross-sectional views for illustrating a method of growing ZnO nanowires on a predetermined region, according to another embodiment of the present invention.

Referring to FIG. 3A, after forming a photoresist layer (not shown) on a substrate 120, a patterned photoresist layer 122 is formed by exposing and developing the photoresist layer using a mask (not shown).

Referring to FIG. 3B, a Ti layer 124 and a Zn layer 126 are sequentially formed on the substrate 120 and the patterned photoresist layer 122. The Ti layer 124 increases the adhesiveness between Zn layer 126 and the substrate 120.

Next, the substrate 120 is immersed in a container 10 (refer to FIG. 1) that contains a mixed solution of 200 ml of 0.01M (mole) hexamethylenetetramine (CH₂)₆N₄) solution and 100 ml of 0.02M (mole) zinc nitrate hexahydrate (Zn(NO₃)₂.6H₂O) solution. Next, a sonicator 30 (refer to FIG. 1) having a titanium tip (not shown) with power of 500 Watt is operated for a predetermined period of time. The hexamethylenetetramine solution and the zinc nitrate hexahydrate solution are mixed substantially 1:1 concentration ratio in the mixed solution, and preferably, 0.001 to 1M, and further preferably, 0.01 to 0.05M, respectively.

Referring to FIG. 3C, when the sonicator 30 is operated for one hour, single-crystalline ZnO nanowires 140 having a diameter of 30 to 700 nm may be grown to a length of 400 nm on the substrate 120 and the patterned photoresist layer 122. The length of the single ZnO nanowires 140 may vary according to the operating time of the sonicator 30.

Next, the single-crystalline ZnO nanowires 140, the Zn layer 126, and the Ti layer 124 on the photoresist layer 122 together with the photoresist layer 122 are removed using a lift-off process. For example, the photoresist layer 122 may be removed by shaking after immersing the substrate 120 in an acetone solution.

Referring to FIG. 3D, the patterned Zn layer 126 is formed on the substrate 120, and the single-crystalline ZnO nanowires 140 are formed on the patterned Zn layer 126.

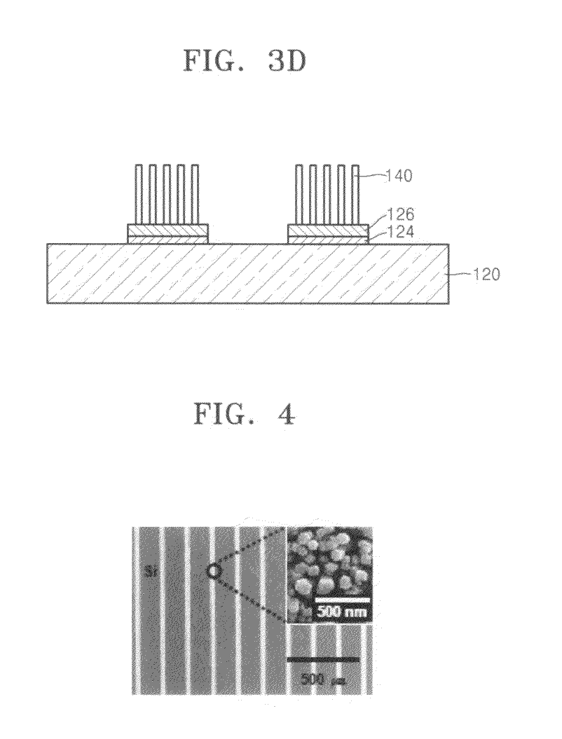

Accordingly, by using the method of fabricating ZnO nanowires according to the present invention, ZnO nanowires may be formed on a predetermined region. This technique may be employed for fabricating ZnO transistors. FIG. 4 is a SEM image of ZnO nanowires grown on a predetermined region of a silicon substrate, that is, on a stripe region.

According to the present invention, since supersonic energy is used at a low temperature in fabricating ZnO nanowires, a device comprising the ZnO nanowires is free to thermal damage due to a fabrication of the ZnO nanowires. Also, since the ZnO nanowires may be correctly formed at a desired location, the technique may be employed to fabricating electronic devices such as ZnO transistors.

Also, since the ZnO nanowires may be grown on various substrates such as a glass substrate or a plastic substrate, the technique may be employed for fabricating flexible display devices.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of fabricating ZnO nanowires, comprising:
(a) forming a Zn layer on a surface of a substrate;
(b) patterning the Zn layer; and
(c) forming ZnO nanowires on the Zn layer by immersing the substrate in a mixed solution made of a solution containing Zn and a solution ionizing Zn, and by using a sonicator.

2. The method of claim 1, wherein the solution that containing Zn is a zinc nitrate hexahydrate solution.

3. The method of claim 2, wherein the solution ionizing Zn is a hexamethylenetetramine solution.

4. The method of claim 3, wherein the mixed solution is made by mixing the hexamethylenetetramine solution and the zinc nitrate hexahydrate solution in a concentration ratio of 1:1.

5. The method of claim 4, wherein concentrations of the hexamethylenetetramine solution and the zinc nitrate hexahydrate solution respectively are 0.001 M(mole) to 1 M.

6. The method of claim 4, wherein concentrations of the hexamethylenetetramine solution and the zinc nitrate hexahydrate solution respectively are 0.01 to 0.05 M.

7. The method of claim 1, wherein the substrate is one selected from the group consisting of a silicon substrate, a plastic substrate, and a glass substrate.

8. The method of claim 1, wherein the solution ionizing Zn is the hexamethylenetetramine solution.

9. A method of fabricating ZnO nanowires, comprising:
(a) forming a patterned photoresist layer on a substrate;
(b) forming a Zn layer on the substrate and the photoresist layer;
(c) forming ZnO nanowires on the Zn layer by immersing the substrate in a mixed solution made of a solution containing Zn and a solution ionizing Zn and by using a sonicator; and
(d) removing the photoresist layer.

10. The method of claim 9, wherein the solution containing Zn is a zinc nitrate hexahydrate solution.

11. The method of claim 10, wherein the solution ionizing Zn is a hexamethylenetetramine solution.

12. The method of claim 11, wherein the mixed solution is made by mixing the hexamethylenetetramine solution and the zinc nitrate hexahydrate solution in a concentration ratio of 1:1.

13. The method of claim 12, wherein concentrations of the hexamethylenetetramine solution and the zinc nitrate hexahydrate solution respectively are 0.001 to 1 M.

14. The method of claim 12, wherein concentrations of the hexamethylenetetramine solution and the zinc nitrate hexahydrate solution respectively are 0.01 to 0.05 M.

15. The method of claim 9, wherein the substrate is one selected from the group consisting of a silicon substrate, a plastic substrate, and a glass substrate.

16. The method of claim 9, wherein the solution ionizing Zn is a hexamethylenetetramine solution.

17. The method of claim 9, wherein the forming of the Zn layer further comprises forming a Ti layer between the photoresist layer and the Zn layer.
